(19) United States
(12) Patent Application Publication
(10) Pub. No.: US 2006/0144521 A1
(43) Pub. Date: Jul. 6, 2006

(54) Qualitatively selective retractable peel plate for labeling

(76) Inventors: James A. Esposito, Burlington, NJ (US); Gregory J. Borsos, Langborne, PA (US)

Correspondence Address: Donald C. Simpson, Esq., 126 Borton Landing Road, Moorestown, NJ, 08057-3055, US

(21) Appl. No.: 11/098,704

(22) Filed: Apr. 4, 2005

Related U.S. Application Data
(60) Provisional application No. 60/560,194, filed on Apr. 7, 2004.

(51) Int. Cl. B65C 9/42; B65C 9/18

(52) U.S. Cl. 156/361; 156/378; 156/541; 156/542; 156/DIG. 45; 156/DIG. 33

(57) ABSTRACT

A peel plate assembly that functions in a normal position of being extended for the purposes of peeling labels from a supply web and directing them toward containers, but which can be retracted selectively when a label is identified as incorrect or faulty, thereby leaving faulty or incorrect labels on the label supply web at least until they are removed from the active site of label application.

### CROSS-REFERENCE TO RELATED APPLICATIONS

This patent application is based on Provisional Patent Application Ser. No. 60/560,194 filed Apr. 7, 2004, the filing date of which is hereby claimed.

The purpose of this invention is to provide a means for applying labels to containers and a means for removing, reconciling, and verifying labels that are determined to be faulty from the labeling system prior to the label application point.

### BACKGROUND OF THE INVENTION

There are a number of labeling systems adapted to apply pressure-sensitive labels to articles or containers at a label-applying station. In a number of the earlier systems, labels are carried toward the site of label application by a web in which the adhesive side of the label is releasably adhered to the web, and holds the label there until the web passes over a peel plate, at which point the adhesive-bearing label is “peeled” from the web. In the earlier models of this type of labeling machine, the label was transferred directly from the label-bearing web to the bottle or container on which the label was to be affixed, and rollers or other means were utilized to press the label against the bottle or container. Typical examples of this type of direct label application will be found in U.S. Pat. Nos. 4,294,644; 4,324,608; 4,427,484; 4,502,910; 4,585,506; and 4,610,753.

In later developed labelers, a label peel plate assembly was used to separate the labels from the web, but in this case, the labels were also applied to the rotating vacuum drum, adhesive side out. As the vacuum drum rotated, the adhesive surface of the label was brought into contact with a bottle or container to be labeled such that the adhesive affixed the label to the bottle or container, and the label was removed from the vacuum drum. Typical examples of this type of labeler will be found in U.S. Pat. Nos. 4,687,535; 4,842,660; 5,256,239; and 5,405,482. A typical prior art system of this type is illustrated schematically in FIG. 1. Labels (1) are carried initially by a web (2) with the adhesive side of the label facing toward the web, and the adhesive holding the label to the web. The labels are delivered to a vacuum drum (7) following stripping from the web (2) at a label pick-up station (5), and deposited on the vacuum drum (7). The vacuum drum (7) continuously advances the stripped labels in a given direction to meet articles to be labeled (3) at a label-applying station (4). Simultaneously, articles to be labeled (3) are continuously advanced past the label applying station (4).

The speed of advance of the articles to be labeled (3) and the speed of advance of the web (2) are sensed continuously by electronic means, and the speed of advance of the web (2) is adjusted as necessary to match the speed of advance of the articles to be labeled (3). In FIG. 1, the articles to be labeled (3) are rotating as they contact the adhesive surface of the label at the label applying site (4), thereby fixing the label to the article to be labeled (3).

The aforementioned patents, while describing effective labeling systems and equipment, are not perfect and, on occasion, “incorrect” or faulty labels may be applied to containers. Incorrect/faulty labels are wrong labels or labels with poor or illegible lot numbers or expiration dates and/or incorrect bar code or part numbers. This is a matter of particular concern to packagers of pharmaceuticals. An incorrectly labeled pharmaceutical container could lead to a costly product recall, and might result in serious injury or even death. The end user relies on the label to take medicine according to a doctor's instructions and could, in fact, be taking the wrong medicine or following wrong directions with adverse results. Accordingly, equipment and systems have been developed for detecting the presence of incorrect/faulty labels. This detection may occur both prior to labeling and subsequent to labeling, or both. U.S. Pat. No. 2,551,364 and U.S. Pat. No. 4,662,971 are examples of labeling equipment that provide error detection prior to application of the labels.

U.S. Pat. No. 5,405,482 describes an advance over the aforementioned patents in that the scanning and removal of incorrect/faulty labels can be conducted without interrupting the essentially continuous operation of the labeling equipment. The label scanner (8) is positioned to “read” the labels while they are still positioned on the carrier web, just prior to the label pick-up station (5) and vacuum roll (7) which will remove the label from the web. A “bad” label-removal unit is positioned between the vacuum roll label pick-up point (5) and the point (4) at which the vacuum roll normally releases and applies a label to a container (3) and is controlled by information from the scanning unit (8) such that when an incorrect label is identified by the scanner, the information is transmitted to and actuates a label-removing device. It is only necessary that the rate and time of label travel be coordinated so that the label removed is the detected incorrect label and not one of the proper labels.

There are some serious drawbacks to the detection system of U.S. Pat. No. 5,405,482. As noted in the patent, the adhesive strength of the label coating overcomes the vacuum strength of the vacuum drum such that the incorrect label is wrapped around the removal roller of the label removal device. These removed labels accumulate on the removal roller and eventually must be removed from the roller by a machine operator. In this regard, see U.S. Pat. No. 5,405,482, column 3, lines 51-54, and column 4, lines 12-14. Because these labels are strongly adhered to each other, they are not readily separated from each other for individual reconciliation and one must depend on the weight of the accumulated, adhered block of labels relative to the weight of a single label for reconciliation purposes, a procedure that is inherently inaccurate and/or inefficient.

The deficiency in the system of U.S. Pat. No. 5,405,482 and all the previously discussed patents is the absence of means for detecting, isolating, and reconciling incorrect/faulty labels prior to label application. In dealing with something as sensitive as pharmaceuticals, one must consider the serious dangers inherent in the fact that any mechanical system may go out of adjustment. Under such circumstances, it is possible that the label removed is not the label that the scanner detected as incorrect, with the result that a correct label is removed and the incorrect/faulty label continues on into the system. In U.S. Pat. No. 5,405,482, at column 4, lines 18-19, it is noted that “unlabeled bottles are easily thereafter identified by operating personnel and may even be reused.” While such detection procedures make identification of the skipped unlabeled container relatively easy, they do not provide an easy and efficient reconciliation between incorrect/faulty labels identified and incorrect/faulty labels removed. It is difficult to impossible for the operator to peel off individual labels from the adhered block of accumulated label faults on the label-remover roll and examine them individually for faults or for reconciliation. Further, by the time the roller has been cleared of the accumulated, adhered “incorrect” or faulty labels, and a reconciliation attempted, a container with an incorrect/faulty label, which through error in the detection process, may be far down the line, and mixed in with the large number of labeled containers coming off the labeling line.

A more recent labeler provides all of the advantages of the foregoing patented devices and, in addition, provides a means for accurate, rapid reconciliation between the incorrect/faulty labels scanned and the incorrect/faulty labels removed. This device and system further has the capability of being adapted to stop the system automatically in the rare event that an incorrect/faulty label is scanned in advance of application to a container but a correct label has, through inadvertence, been removed, rather than an incorrect/faulty label. This device is shown in detail in FIGS. 2 through 5. FIG. 2 illustrates the more recent system in an inactive state, i.e. at a time when no incorrect/faulty label has yet been detected or, if detected, the incorrect/faulty label has not yet reached the point of removal. FIG. 3 is an illustration of the more recent invention in which the label-removal device is activated for the removal of an incorrect/faulty label. FIG. 4 illustrates a preferred embodiment of the more recent invention. FIG. 5 is a front elevation in partial section of the preferred embodiment of FIG. 4, and showing the location of the torque clutch relative to the unwind mechanism.

Pressure sensitive labels are fed from a label pick-up station (5) onto a vacuum drum (7) as described above with regard to the prior art. The drum is servo-driven and in synchronization with a container that is traveling down a conveyor system toward label application site (4). The vacuum drum (7) applies the labels to containers (3). Each label is scanned one by one with a vision camera system (8) that detects various printed items on the label. If any of these items is incorrect, the label dispenser at label pick-up station (5) will still dispense the incorrect/faulty label onto the vacuum drum (7) but the incorrect/faulty label will be electronically tracked, even though dispensed along with good labels onto the vacuum drum (7). The tracked, incorrect/faulty label will be removed from the vacuum drum (7) by a suitable pick-off assembly (14) actuating against the label supply to picked-off incorrect/faulty label will be delivered and adhered to label supply web (9). The pick-off assembly may comprise an actuating arm terminating in a roller, as shown in FIGS. 2 and 3, or may terminate in a low-friction bearing surface; in either case, the label supply web is free to move easily between the unwind spool (10) and the rewind assembly (13). The label supply web (9) is fed via the unwind spool (10) and a dancer arm assembly (11) that ensures tension of the label supply web between the unwind assembly (12) and the rewind assembly (13). When the pick-off assembly (14) is actuated, it pushes the label supply web against adhesive surface of the faulty label on the drum (7). When the pick-off roller assembly (14) is actuated, the unwind dancer arm (11) will release a friction belt, enabling the unwind spool (10) to spin. Vacuum drum (7) will transport the label, and will also drive label supply web (9) which will in turn drive the label pick-off roller (14). When an incorrect/faulty label is detected, it is transferred from the vacuum drum onto the label supply web (9). Scanner (15) is essentially a counter/rejected label verifier that detects each transferred label to ensure that the label has been removed from vacuum drum (7) and that the number of labels removed corresponds to the number of incorrect/faulty labels detected. A torque or servo motor rewind system (16) and dancer arm (17) take up the excess web material together with the adhered faulty label that is being pushed by the vacuum drum. After the label is applied to web (9), the pick-off roller assembly (14) is deactivated and returns to its unengaged position. The gap between incorrect labels on the label supply web can be determined by the length of time that the pick-off roller assembly (14) is activated. The user can reconcile the incorrect labels visually on the label supply web, on the wound web roll, or on the unwound web roll to ensure that the label counters are correct, without the necessity and time associated with separating the stack of incorrect/faulty labels adhering to each other from the take-off roll of the U.S. Pat. No. 5,405,482 patent. These rolls may also be used as a permanent record of reconciliations and fault corrections. Optionally, it is possible to replace scanner (15) with a reconciling scanner similar to scanner (8) or use such in addition to scanner (15). In this case, the reconciling scanner would be looking for a correct label mixed in with the incorrect/faulty labels on web (9). When a correct label is detected, the reconciling scanner can send a signal to shut down the line until the error in the labeled containers is correspondingly corrected, or otherwise notify the operator of the error.

In the embodiment of FIGS. 2 and 3, the unwind spool 10 and dancer arm assembly 111 co-acted to maintain tension of the label supply web between the unwind assembly 12 and the rewind assembly 13. As shown in FIGS. 4 and 5, dancer arm assembly 11 has been eliminated, and a torque clutch 18 has been added to the unwind assembly 12, thereby providing a simpler and more efficient manner of controlling tension in the label supply web.

A detailed examination of all of the aforementioned prior art will show one common defect insofar as quality control is concerned. In every case just described, all labels, good or bad, are removed by the label peel plate from the label supply web. As indicated, in some of the prior art, the faulty labels are actually applied to the bottles or containers, which then must be removed from the system. In others, all of the labels are applied to a vacuum drum, and the identified faulty labels are picked off the vacuum drum just prior to application of the labels to the bottles or containers. One of the major purposes of the vacuum drum is to provide a transition between the label peel plate and the label application point so that faulty labels can be removed before being applied to a bottle or container. It is the object of this invention to eliminate the vacuum drum from the system, and to apply the labels directly from the peel plate onto the bottles or containers, but in which faulty labels are not removed from the supply web.

### BRIEF SUMMARY OF THE PRESENT INVENTION

The present invention provides all of the advantages of the foregoing prior art devices and, in addition, provides for selectively retaining faulty labels on the label supply web, while permitting correct labels to be applied directly to bottles or containers. This is accomplished by utilizing a peel plate assembly that functions in a normal position of being extended for the purposes of peeling labels from the supply web, and directing them toward the bottles and containers, but which can be retracted selectively when a label is identified as incorrect or faulty, thereby leaving faulty or incorrect label on the label supply web at least until it is removed from the active site of label application.

### BRIEF DESCRIPTION OF THE DRAWINGS

FIG. 6 is a schematic representation of a label application system having a retractable peel plate and a reconciliation system.

FIG. 7 is an enlarged view of the retractable peel plate system in its normally extended position for applying a good label to a bottle or container.

FIG. 8 is an enlarged view of the retractable peel plate of the present invention in which an incorrect/faulty label has been identified and the peel plate is retracted from its normal label-applying position to one in which the faulty label remains on the label supply web and is removed from the label application area.

FIGS. 9 and 10, respectively, are a front elevation and a top view of the normally extended unretracted peel plate assembly of FIG. 7.

FIGS. 11 and 12, respectively, are a front elevation and a top view of the retracted peel plate assembly of FIG. 8.

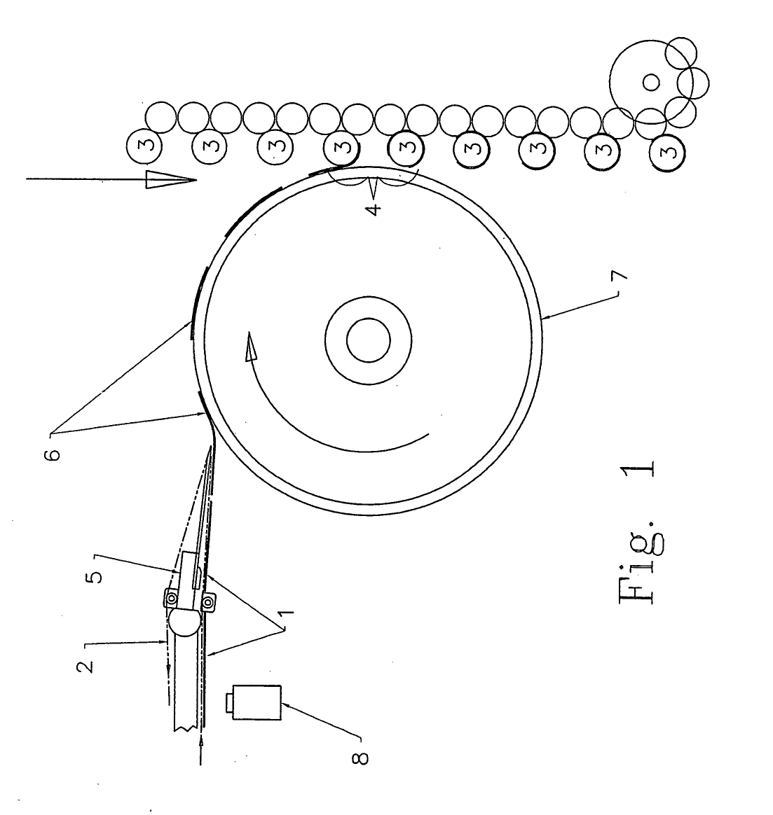

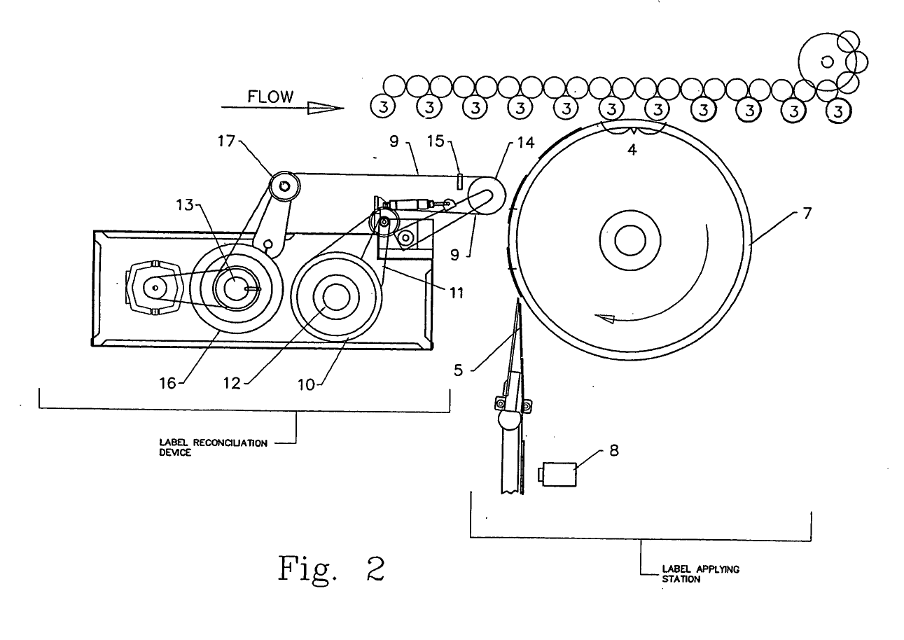

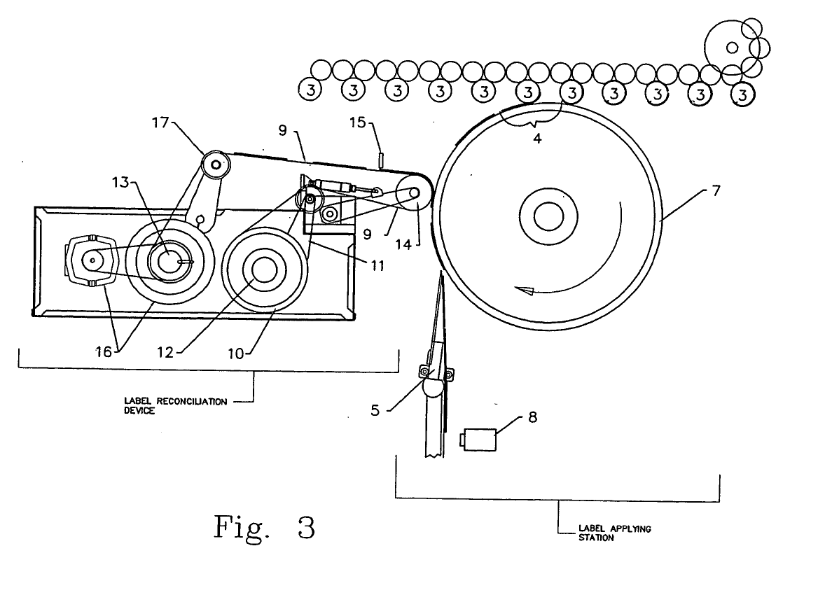

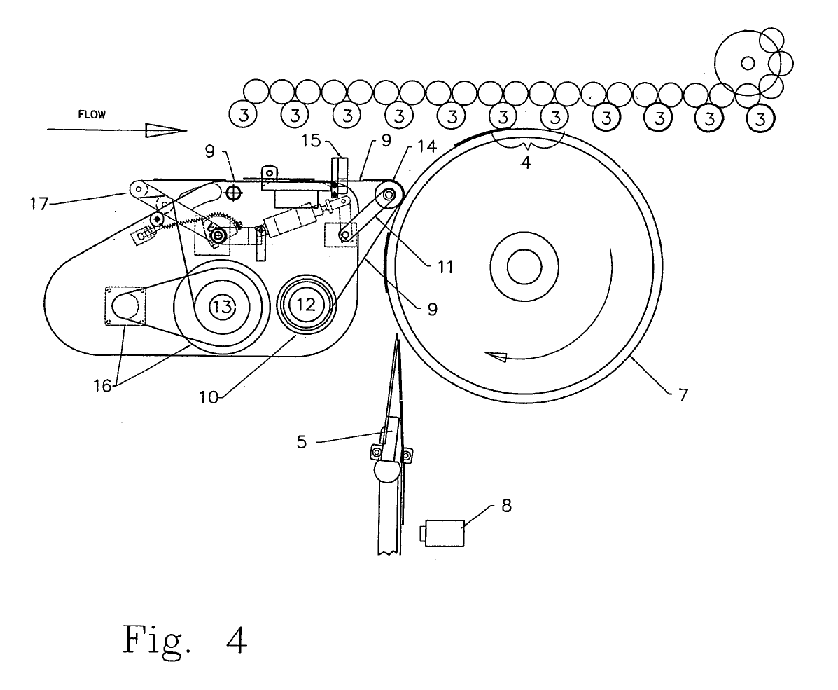

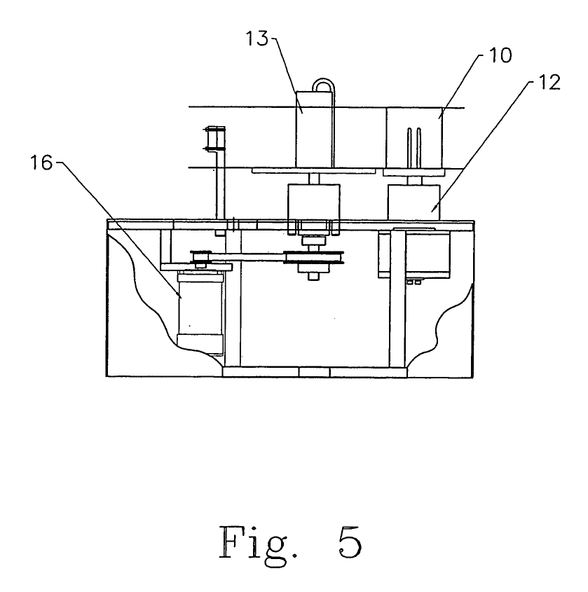

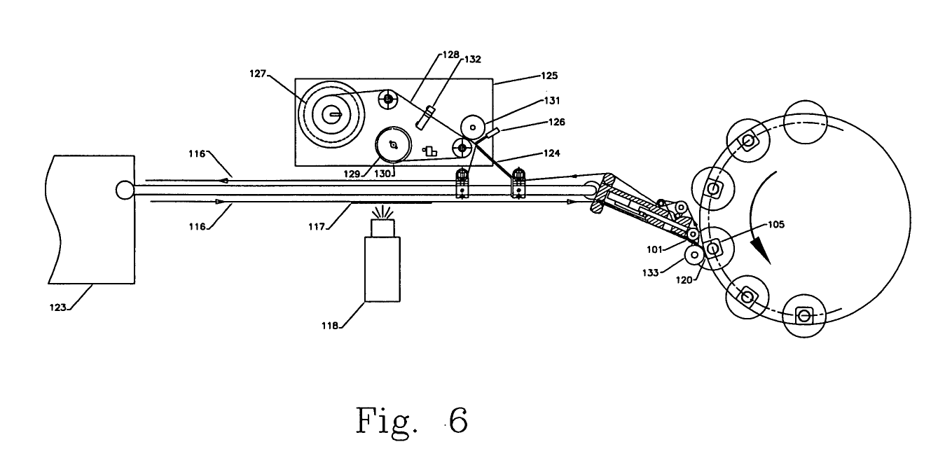

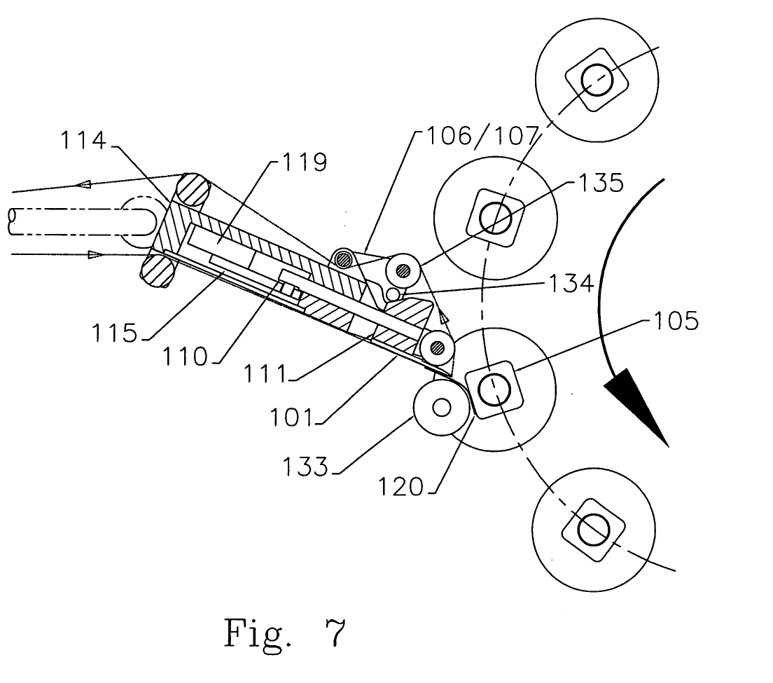

### DETAILED DESCRIPTION OF THE INVENTION

The retractable peel plate assembly is a mechanical assembly that can be activated pneumatically, hydraulically, or electromagnetically, and replaces a standard “static” peel plate assembly. The retractable peel plate Assembly allows a rejected label to bypass the “peel and apply” point and remain on the web. While hereinafter the retractable peel plate is describe as being reciprocated into and out of actuation when needed, it can also be pivoted into and out of actuation. The term “retractable” is intended to encompass both of such actuation-deactuation embodiments.

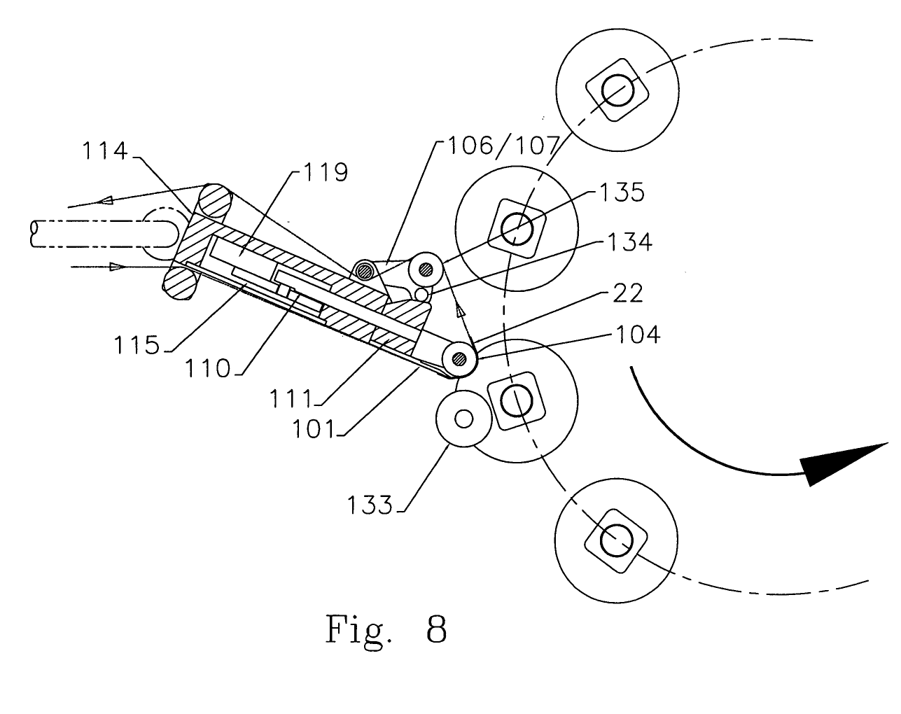

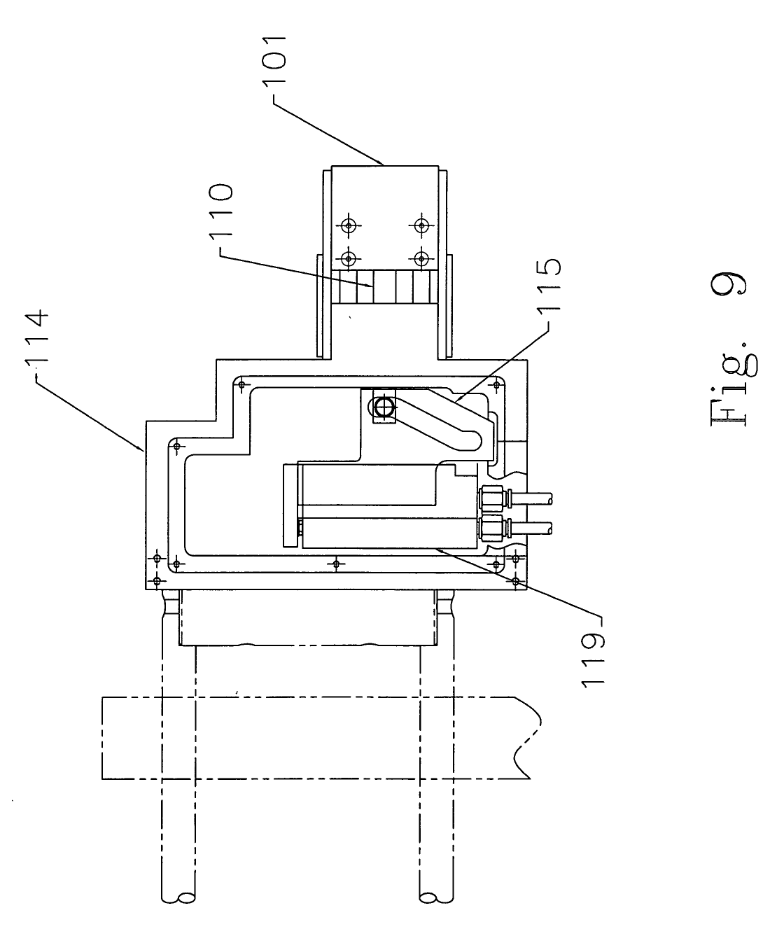

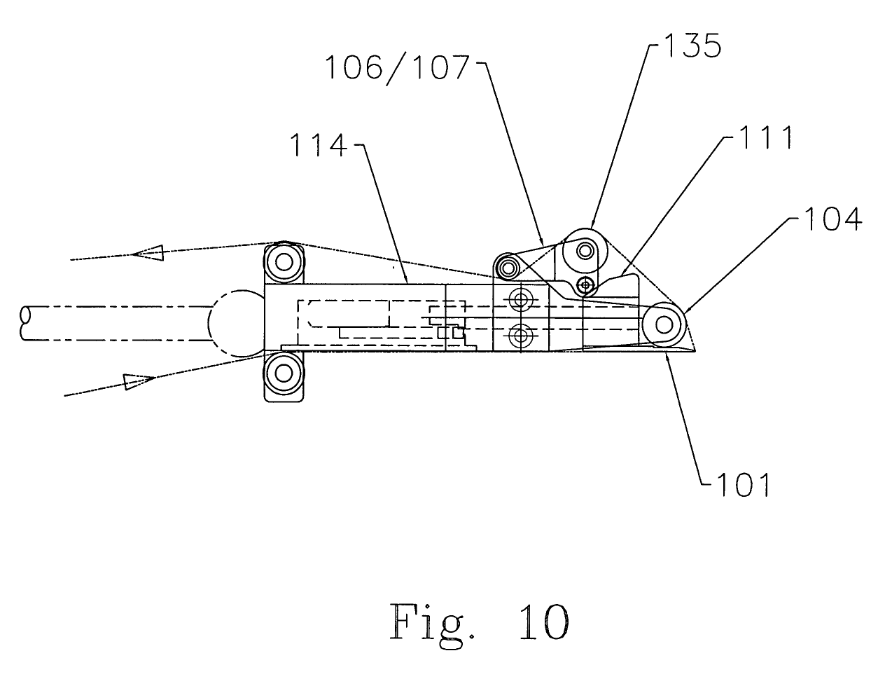

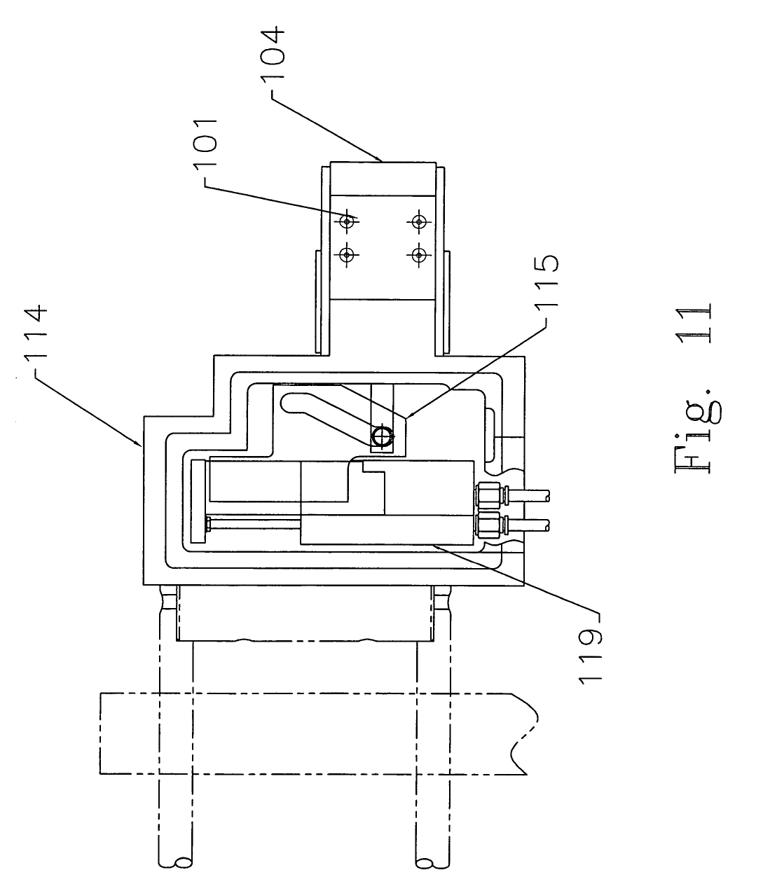

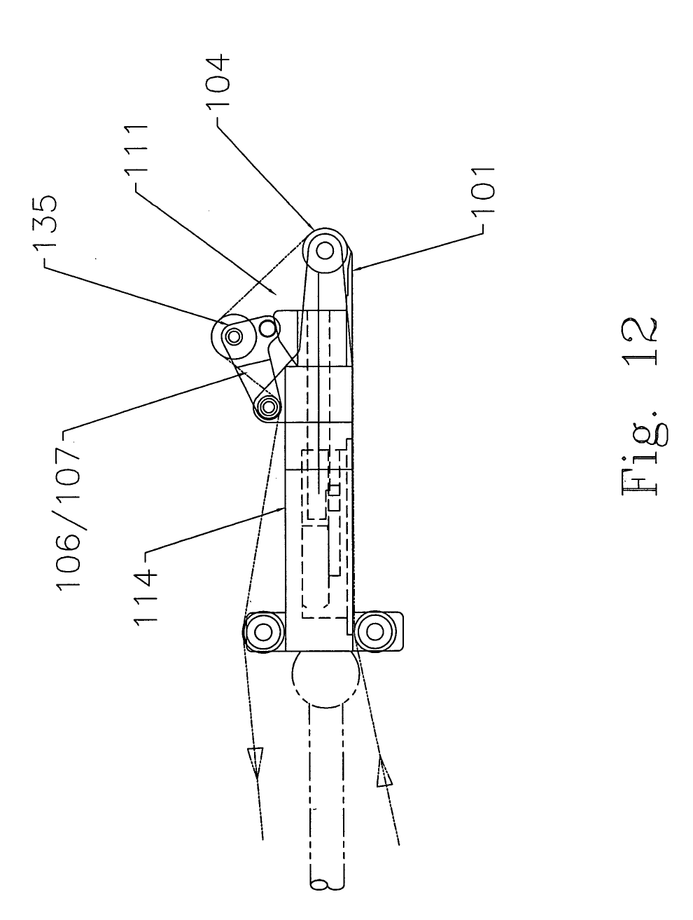

When a label (117) traveling on the label supply web (116) is passed or rejected by the inspection system (118) it is tracked by the CPU (central processing unit, computer control) as it moves to the peel plate (101). If the label has passed inspection, it is applied to the product (120) as the product passes the peel plate (101). The label is applied by being fed between the product and a foam roller (133) and pressed onto the product. If the label is rejected by the inspection system, the peel plate (101) is retracted (FIG. 8). This action is accomplished by a pneumatic slide cylinder (119) located inside the peel body (114). The pneumatic slide cylinder (119) has a trapped cam (115) mounted to it. This 330 cam pulls back on a cam follower actuator rod (110) typically 0.75 inch. The actuator using a 16 mm×40 mm stroke cylinder rod is attached to the peel plate block (111) which holds the peel plate (101).

Retracting the peel plate creates excess slack that must be compensated for. Built into the peel plate block (111) is a two-part linear cam profile. As the peel plate block (111) moves, two cam followers (134) follow the profile. This motion is transferred via slack plates (106 and 107) to a pivoting roller (135). The roller (135) then moves out to take-up the appropriate amount of excess label supply web. The roller is held against the cam by the tension of the web.

With the peel plate edge retracted, the rejected label (122) remains on the label supply web and follows around a 1″ diameter roller (104). After the leading edge of the rejected label clears the peel plate, the peel plate moves back to the application position for the next label. The rejected label remains on the label supply web as the web is pulled back towards the push/pull assembly (123), on the pull side. Approximately half way to the push/pull assembly (123), the label reaches the second part of the system, the label reconciler (125).

At the label reconciler (125), the rejected label begins to dispense from the stationary peel plate (124). The label is detected by a label detection sensor (126). This sensor feeds back this information to the CPU which activates the take-up servo-motor (127). As the take-up servo-motor rotates it pulls the collection media (128) (e.g. a paper web) at a speed that matches the speed that the rejected label is traveling. The media supply (129) comes from a roll mounted on a magnetic clutch assembly (130). As the rejected label transfers, it is pressed onto the media by a foam roller (131). The motor (127) continues to pull the media (128) until the label reaches the label detection sensor (132). At this time the label has cleared the label detection sensor (126). The Label Reconciler is now ready for the next rejected label.

Once a faulty label has been removed, the operator has several options available, all of which can be controlled by appropriate programming of the CPU. The system can be permitted to operate with the container delivery line and the label-feeding line operating with no change of speed. In such case, the container which would have received the faulty label will continue through the system unlabeled; the unlabeled container can be recovered thereafter and returned to the container feed line for labeling.

In a second embodiment, the container feed line can be slowed sufficiently or even momentarily stopped to correspond to the time that it takes for a proper label to reach the label application point and thereby compensate for the absence of the faulty label, and avoid the occurrence of unlabeled containers. In the preferred embodiment, the speed of the container feed line is maintained and the speed of the label feed is momentarily increased sufficiently to compensate for the undelivered faulty label, thereby also avoiding the occurrence of unlabeled containers.

It is also possible, of course, to have the CPU direct a combination of container feed slowing and label feed speed-up. In general, however, it is far easier to adjust the label feed line on a moment-to-moment basis than it is to momentarily slow down the container feed line, coupled with a resumption of speed thereafter.

What is claimed is:

1. In a labeling system for the continuous labeling of containers in which labels having adhesive on one side and printing on the face thereof are carried toward the site of label application by a web with the adhesive side of the label releasably adhered to the web and the web holds the label thereon until the web passes over a peel point of a peel plate interacting with said web for the separation of said adhesive-bearing label from the web, the improvement which comprises means for controllably retracting said peel plate from, and restoring it to, label peeling interaction with said web; scanning means positioned in advance of said peel plate for scanning the printed face on labels being conveyed by said web for incorrect or faulty information; and means for correlating scanner information with said peel plate assembly to retract said peel plate without removal of any faulty label detected by said scanning means and returning said peel plate into label peeling position after said faulty label has passed the peel point for the continued removal of acceptable labels.

2. In the method of applying labels to a container in which labels having adhesive on one side and informational printing on the other side are carried on a moving web toward the point of application of said label to a container by a web to which the adhesive side of said label is releasably attached and in which said labels are removed from said web by passage over the peel point of a peel plate, the improvement which comprises scanning said label face for faults or errors in advance of said peel point and permitting faulty labels to be retained on said web by retracting said peel plate from the peel point and returning said peel plate to the peel point when said web bearing said faulty label has passed the peel point without removal therefrom.
